(19) United States
(12) Patent Application Publication
(10) Pub. No.: US 2006/0023683 A1
(43) Pub. Date: Feb. 2, 2006

(54) Handoff system and method between mobile communication network and wireless LAN

(75) Inventors: Sang-Do Lee, Suwon-si (KR); Dong-Keon Kong, Suwon-si (KR); Hye-Won Baek, Seongnam-si (KR); Sang-Jun Moon, Yongin-si (KR); Ji-Cheol Lee, Yongin-si (KR); Eun-Young Chung, Suwon-si (KR); Heung-Chul Jung, Suwon-si (KR); Jong-Bum Pyo, Yongin-si (KR); Sung-Won Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co. Ltd.

(21) Appl. No.: 11/191,264

(22) Filed: Jul. 28, 2005

(30) Foreign Application Priority Data
Jul. 28, 2004 (KR) 2004-59296
Aug. 4, 2004 (KR) 2004-61494

(51) Int. Cl. H04Q 7/00; H04Q 7/24; H04Q 7/20

(52) U.S. Cl. 370/338; 370/331; 455/436

(57) ABSTRACT

A handoff system and method is provided for performing handoff from a mobile communication network, including a packet data service node (PDSN) connected to a base station system (BSS) for supporting an Internet protocol (IP) routing function, to a wireless local area network (LAN) including an access router (AR) supporting the IP routing function. An access terminal (AT) detects its movement to the wireless LAN and exchanges information with the AR for tunneling between the PDSN and the AR. The AR sets up a tunnel for packet delivery between the AR and the PDSN, and delivers packets delivered from a correspondent node (CN) to the AT via the set tunnel.

### CROSS-REFERENCE TO RELATED APPLICATIONS

This application claims the benefit under 35 U.S.C. §119(a) of Korean Patent Application No. 10-2004-0059296 entitled “Handoff System And Method Between Mobile Communication Network And Wireless LAN” filed in the Korean Intellectual Property Office on Jul. 28, 2004, and Korean Patent Application No. 10-2004-0061494 entitled “Handoff System And Method Between Mobile Communication Network And Wireless LAN” filed in the Korean Intellectual Property Office on Aug. 4, 2004, the entire disclosures of both of which are incorporated herein by reference.

### BACKGROUND OF THE INVENTION

1. Field of the Invention

The present invention relates generally to a handoff system and method between a mobile communication network and a wireless Local Area Network (LAN). More particularly, the present invention relates to a system and method for enabling an access terminal capable of accessing both a mobile communication network and a wireless LAN, to perform handoff from the mobile communication network to the wireless LAN.

2. Description of the Related Art

Early mobile communication networks were developed for voice communication. However, with the rapid progress of communication technology, the mobile communication network is now evolving into a system capable of supporting high-speed data transmission, in which a user can receive not only the common voice service, but also receive a multimedia service such as E-main, still image, and moving image services. As is well known to those skilled in the art, 3^{rd} generation (3G) mobile communication systems supporting both a voice service and a packet service are classified into a Code Division Multiple Access (CDMA) 2000 1× system, a 1× Evolution Data Only (EV-DO) system capable of high-speed packet transmission, and an Evolution of Data and Voice (EV-DV) system, all of which are synchronous systems, and an asynchronous Universal Mobile Telecommunication Systems (UMTS) system.

In a mobile communication network of FIG. 1, an access terminal (AT) 10 capable of accessing a mobile communication network, is connected to a base station system (BSS) 20 through a radio channel. The AT 10 is a dual-mode terminal capable of accessing both a mobile communication network and a wireless LAN, and the dual-mode terminal is called a “hybrid access terminal”. Herein, the dual-mode terminal will be referred to as an “access terminal (AT)”. The BSS 20 is connected to an packet control function (PCF) (not shown), that controls an exchange of packet data between the AT 10 and the BSS 20 to perform packet data communication.

The PCF is connected to a packet data service node (PDSN) 30 that transmits and receives packet data. The PDSN 30 provides an Internet protocol (IP) routing function and a vertical handoff function to the AT 10 that accesses an IP network 80 via the mobile communication network. Further, the PDSN 30 performs point-to-point protocol (PPP) connection on the AT 10 that accesses the IP network 80 via the mobile communication network.

In Mobile IP, the PDSN 30 can serve as a foreign agent (FA). The PDSN 30 allocates an IP address used by the AT 10 by performing link control protocol (LCP) negotiation (or LCP association) with the AT 10, performing challenge handshake authentication protocol (CHAP) authentication, and thereafter, performing IP control protocol (IPCP) negotiation (or IPCP association) with the AT 10.

In the wireless LAN of FIG. 1, the AT 10 can perform wireless communication within the coverage of an access point (AP) 40 using a radio frequency. The AT 10, performing wireless communication, selects one of a plurality of APs by measuring the strength of signals therefrom, and then accesses the selected AP 40. The AP 40 processes a wireless LAN access protocol, and performs a bridge function between a wireless LAN and a wired LAN. For example, the AP 40 of FIG. 1 is connected to an access router (AR) 50 through a wire. The AR 50 provides an IP routing function, a vertical handoff function, and an accounting/authentication function to the AT 10 that accesses the IP network 80 via the wireless LAN.

The mobile communication network and the wireless LAN attempt to provide full mobility to a user of the AT 10. That is, even though the user of the AT 10 moves from the mobile communication network to the wireless LAN, the communication should continue seamlessly. In order to provide such mobility to the user, the communicating AT 10 should preferably perform handoff while moving from the mobile communication network to the wireless LAN and vice versa.

Generally, the term “handoff” refers to a process of maintaining a channel so that a call continues even when a communicating AT moves between base stations (that is, a BSS or AP). The general handoff can be roughly divided into categories including a hard handoff and a soft handoff as known to those skilled in the art, and accordingly, a description thereof will be omitted herein.

Unlike the general handoff, the vertical handoff refers to internetwork handoff. That is, the vertical handoff occurs when the AT 10 that was allocated an IP address from the PDSN 30 via the BSS 20 and has created sessions of upper layers, for example, an application layer and a TCP/UDP layer, moves to the wireless LAN.

During the vertical handoff, the AT 10 cannot receive packets transmitted from the mobile communication network and must be allocated a new IP address in order to access the wireless LAN, so that it cannot maintain the sessions of the upper layers.

Every time the type of network that the AT 10 accesses changes, a new protocol for updating an IP address of the AT 10 is required. In this case, the AT 10 is dynamically allocated an IP address using a dynamic host configuration protocol (DHCP). A format of the DHCP message is well known to those skilled in the art, therefore a description thereof will be omitted herein.

When the AT 10 moves from the mobile communication network to the wireless LAN as stated above, an IP address of the AT 10 is updated and IP packets are delivered from a correspondent node (CN) 60, which is an external server or a host, to the AT 10 via the IP network 80, the AR 50, and the AP 40. However, in the network configuration of FIG. 1, it is possible to use Mobile IP in order to maintain the upper layer sessions and provide a seamless handoff during the vertical handoff process for the AT 10.

FIG. 2 is a diagram illustrating a conventional IP packet delivery process for the case where an AT moves from a mobile communication network to a wireless LAN using Mobile IP.

When Mobile IP is used, an AT 10 can maintain the same IP address, even after the vertical handoff, by using a home address managed through a home agent (HA) 70. The HA 70 intercepts a packet being delivered to the AT 10 via the existing IP packet delivery route, and delivers (or forwards) the intercepted packet to the AT 10 through a new IP tunneling route, providing a seamless handoff service to a certain extent. However, in Mobile IP, a time delay may occur due to mobility determination and signaling transmission, and traffic is concentrated on the HA 70 because the HA 70 must intercept the packets being delivered from the CN 60 to the AT 10.

Accordingly, a need exists to provide a handoff system and method between a mobile communication network and a wireless LAN for providing seamless service for a mobile AT and which minimizes delays.

### SUMMARY OF THE INVENTION

It is, therefore, an object of the present invention to substantially solve the above and other problems, and to provide a handoff system and method between a mobile communication network and a wireless LAN for providing a seamless service when an AT moves from the mobile communication network to the wireless LAN.

It is another object of the present invention to provide a handoff system and method between a mobile communication network and a wireless LAN for transmitting/receiving IP packets using the existing IP address when an AT moves from the mobile communication network to the wireless LAN.

It is yet another object of the present invention to provide a handoff system and method between a mobile communication network and a wireless LAN for preventing a loss of IP packets and reducing a call processing time by simplifying a handoff process when an AT moves from the mobile communication network to the wireless LAN.

It is yet another object of the present invention to provide a handoff system and method between a mobile communication network and a wireless LAN for maintaining sessions of upper layers when an AT moves from the mobile communication network to the wireless LAN.

According to one aspect of the present invention, a method is provided for performing handoff from a mobile communication network, including a packet data service node (PDSN) connected to a base station system (BSS) for supporting an Internet protocol (IP) routing function, to a wireless local area network (LAN) including an access router (AR) supporting the IP routing function. The method comprises the steps of detecting by an access terminal (AT), its movement to the wireless LAN, exchanging between the AT and the AR, information for tunneling between the PDSN and the AR, setting up a tunnel for packet delivery between the AR and the PDSN, and delivering packets to the AT via the set tunnel.

According to another aspect of the present invention, a wireless communication system is provided for performing handoff of an access terminal (AT) that moves from a mobile communication network, including a packet data service node (PDSN) connected to a base station system (BSS) for supporting an Internet protocol (IP) routing function, to a wireless local area network (LAN) including an access router (AR) supporting the IP routing function. The system comprises the AT having a dual-mode function capable of accessing both the mobile communication network and the wireless LAN for exchanging information with the AR for tunneling between the PDSN and the AR when the AT moves from the mobile communication network to the wireless LAN, and the AR for receiving the tunneling information from the AT, setting up a tunnel for packet delivery with the PDSN according to the received tunneling information, and delivering packets to the AT via the set tunnel.

According to yet another aspect of the present invention, a method is provided for performing handoff from a mobile communication network, including a packet data service node (PDSN) connected to a base station system (BSS) for supporting an Internet protocol (IP) routing function, to a wireless local area network (LAN) including an access router (AR) supporting the IP routing function. The method comprises the steps of detecting by an access terminal (AT), its movement to the wireless LAN, exchanging, by the AT, information with the AR for temporary tunneling between the PDSN and the AR before the handoff to the wireless LAN, setting up a temporary tunnel for packet delivery between the AR and the PDSN, transmitting by the AT, a handoff complete message for tunneling request to the AR after the handoff to the wireless LAN, setting up a tunnel between the AR and the PDSN, and delivering packets to the AT via the set tunnel.

According to yet another aspect of the present invention, a method is provided for performing handoff by an access terminal (AT) that moves from a mobile communication network, including a packet data service node (PDSN) connected to a base station system (BSS) for supporting an Internet protocol (IP) routing function, to a wireless local area network (LAN) including an access router (AR) supporting the IP routing function. The method comprises the steps of detecting the AT movement from the mobile communication network to the wireless LAN, exchanging information with the AR for tunneling between the PDSN and the AR and, if a tunnel for packet delivery between the AR and the PDSN is set up, receiving packets via the set tunnel.

According to still another aspect of the present invention, a method is provided for performing handoff by an access terminal (AT) that moves from a mobile communication network, including a packet data service node (PDSN) connected to a base station system (BSS) for supporting an Internet protocol (IP) routing function, to a wireless local area network (LAN) including an access router (AR) supporting the IP routing function. The method comprises the steps of detecting the AT movement from the mobile communication network to the wireless LAN, exchanging information with the AR for temporary tunneling between the PDSN and the AR before the handoff to the wireless LAN, transmitting a handoff complete message for tunneling request to the AR after the handoff to the wireless LAN if a temporary tunnel for packet delivery between the AR and the PDSN is set up, and if a tunnel between the AR and the PDSN is set up, receiving packets via the set tunnel.

According to still another aspect of the present invention, a handoff method is provided between a mobile communication network and wireless local area network (LAN) performed by an access router (AR) in a wireless communication system for performing handoff of an access terminal (AT) that moves from the mobile communication network, including a packet data service node (PDSN) connected to a base station system (BSS) for supporting an Internet protocol (IP) routing function, to the wireless LAN including the AR supporting the IP routing function. The method comprises the steps of detecting movement of the AT from the mobile communication network to the wireless LAN and exchanging information with the AT for tunneling between the PDSN and the AR, setting up a tunnel for packet delivery with the PDSN, and delivering packets to the AT via the set tunnel.

According to still another aspect of the present invention, a handoff method is provided between a mobile communication network and wireless local area network (LAN) performed by an access router (AR) in a wireless communication system for performing handoff of an access terminal (AT) that moves from the mobile communication network, including a packet data service node (PDSN) connected to a base station system (BSS) for supporting an Internet protocol (IP) routing function, to the wireless LAN including the AR supporting the IP routing function. The method comprises the steps of detecting movement of the AT from the mobile communication network to the wireless LAN and exchanging information with the AT for temporary tunneling between the PDSN and the AR before the handoff to the wireless LAN, setting up a temporary tunnel for packet delivery with the PDSN, receiving a handoff complete message for tunneling request from the AT after the handoff of the AT to the wireless LAN, and if a tunnel to the PDSN is set up, delivering packets to the AT via the set tunnel.

### BRIEF DESCRIPTION OF THE DRAWINGS

The above and other objects, features and advantages of the present invention will become more apparent from the following detailed description when taken in conjunction with the accompanying drawings, in which:

FIG. 1 is a block diagram illustrating a conventional IP packet delivery route between a mobile communication network and a wireless LAN;

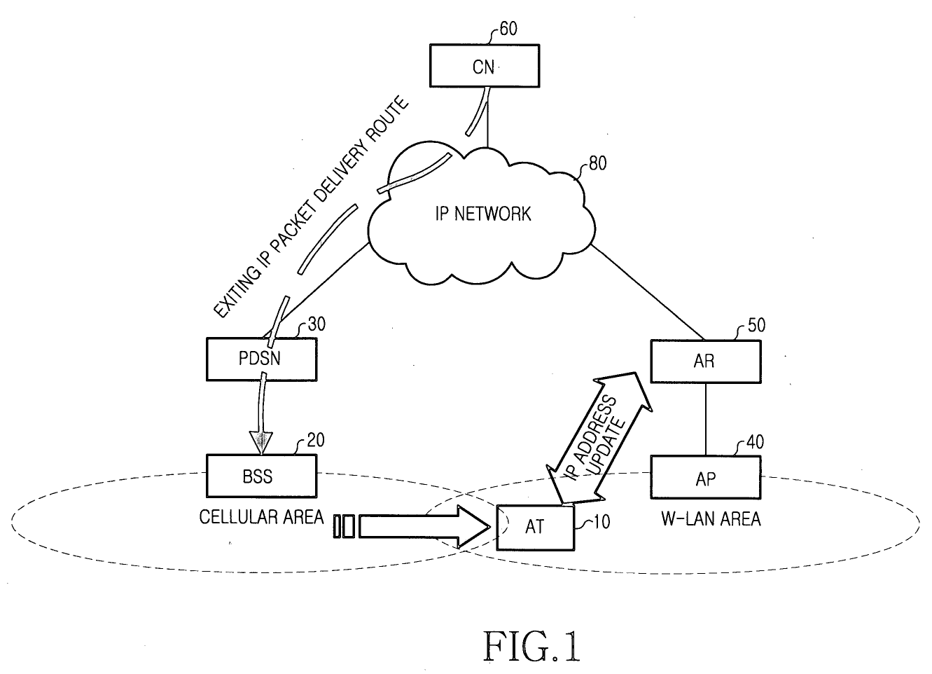

FIG. 2 is a block diagram illustrating a conventional Mobile IP-based IP packet delivery route between a mobile communication network and a wireless LAN;

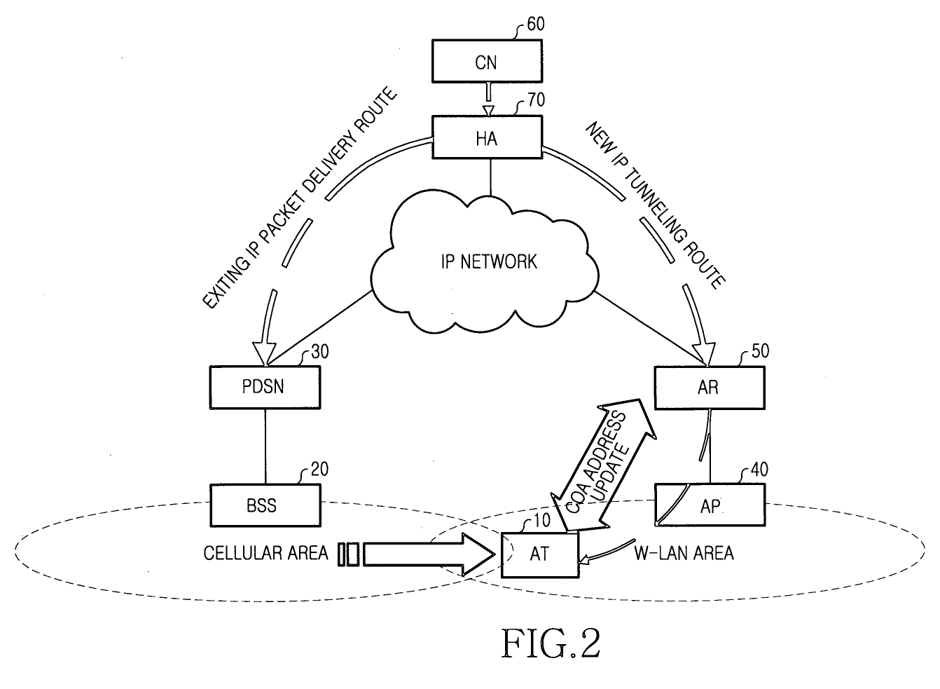

FIG. 3 is a block diagram illustrating a handoff system between a mobile communication network and a wireless LAN according to an embodiment of the present invention;

FIG. 4 is a diagram illustrating protocol stacks used for performing handoff between a mobile communication network and a wireless LAN according to an embodiment of the present invention;

FIG. 5 is a signaling diagram illustrating a handoff method between a mobile communication network and a wireless LAN according to an embodiment of the present invention;

FIG. 6 is a signaling diagram illustrating a handoff release method between a mobile communication network and a wireless LAN according to an embodiment of the present invention;

FIG. 7 is a block diagram illustrating an IP packet delivery route formed before handoff between a mobile communication network and a wireless LAN according to another embodiment of the present invention;

FIG. 8 is a block diagram illustrating an IP packet delivery route formed after handoff between a mobile communication network and a wireless LAN according to another embodiment of the present invention; and

FIG. 9 is a signaling diagram illustrating a handoff method between a mobile communication network and a wireless LAN according to another embodiment of the present invention.

Throughout the drawings, like reference numerals will be understood to refer to like parts, components and structures.

### DETAILED DESCRIPTION OF THE EXEMPLARY EMBODIMENTS

Several exemplary embodiments of the present invention will now be described in detail with reference to the annexed drawings. In the following description, detailed descriptions of functions and configurations well known to those skilled in the art incorporated herein have been omitted for clarity and conciseness.

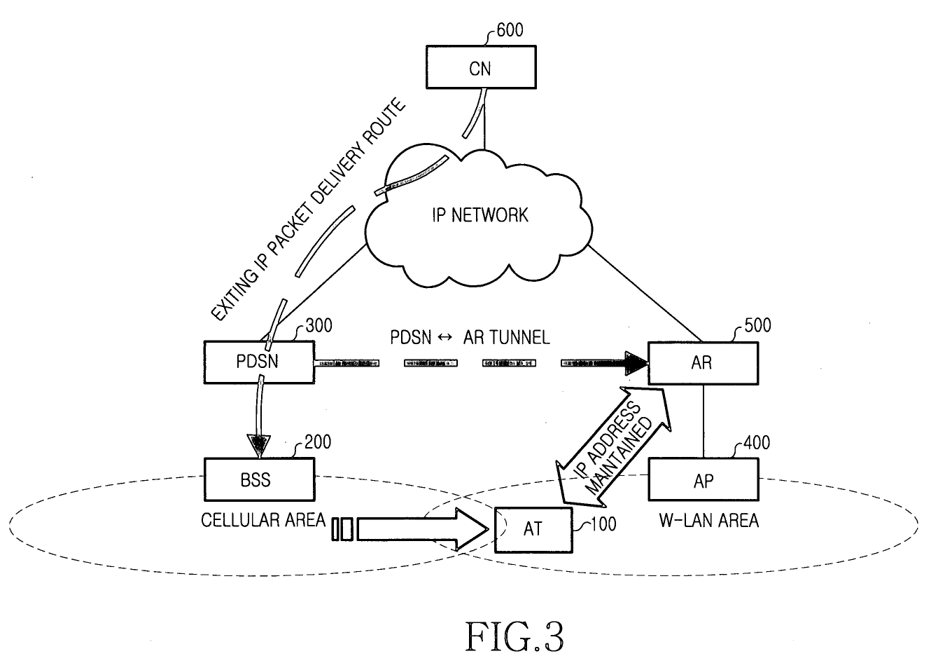

FIG. 3 illustrates a handoff system between a mobile communication network and a wireless LAN according to an embodiment of the present invention. The wireless LAN comprises Portable Internet, also known as Wireless Broadband (WiBro). An AP 400 and an AR 500 in the wireless LAN correspond to a RAS and an ACR in WiBro, respectively.

In the example shown in FIG. 3, it can be assumed for the following description that an AT 100, exchanging IP packets with a CN 600 that accesses the mobile communication network and performs data communication, moves from the mobile communication network to the wireless LAN. While the AT 100 exchanges packet data with a BSS 200, if the strength of signals from the BSS 200 becomes lower than a predetermined threshold and the strength of signals from the AP 400 in the wireless LAN becomes greater than a predetermined threshold, the AT 100 detects handoff from the mobile communication network to the wireless LAN. Upon detecting the handoff from the mobile communication network to the wireless LAN, the AT 100 searches for (or selects) an AR 500 supporting handoff between the mobile communication network and the wireless LAN, and provides an AT IP address and a PDSN IP address, both of which were used by the AT 100 in the mobile communication network, to the selected AR 500.

To maintain the existing IP address used in the mobile communication network before the AT 100 is handed off to the wireless LAN, the AR 500 sets up a tunnel between the AR 500 in the wireless LAN and a PDSN 300 in the mobile communication network. When the AT 100, after moving to the wireless LAN, delivers IP packets up to the CN 600 through the set tunnel, the IP packets are not delivered to the CN 600 by a routing function of the AR 500, but are delivered to the PDSN 300 through the tunnel thereto, and then delivered to the CN 600 by a routing function of the PDSN 300.

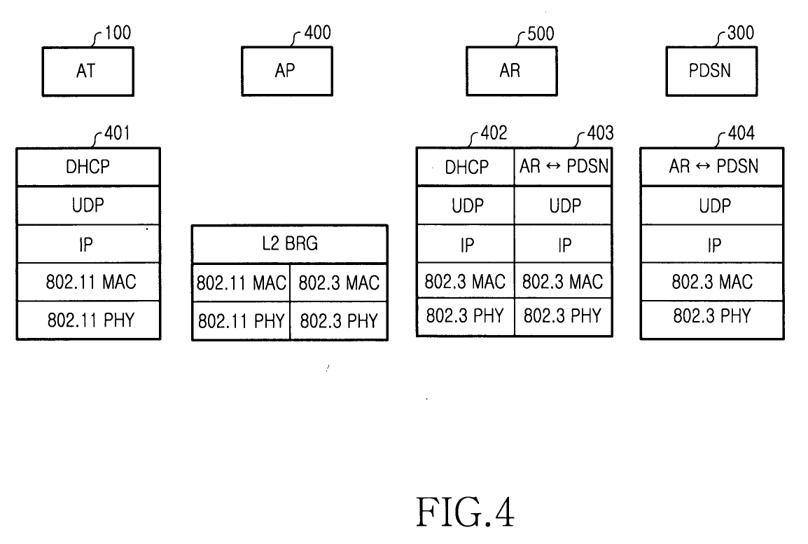

FIG. 4 illustrates exemplary protocol stacks used for performing handoff between a mobile communication network and a wireless LAN according to an embodiment of the present invention.

Referring to FIG. 4, the AT 100 comprises an 802.11 physical (PHY) layer, an 802.11 MAC layer, an IP layer, a UDP layer, and a DHCP layer 401, to access the wireless LAN. Herein, a protocol stack used by the AT 100 to access the mobile communication network is not shown. The AT 100, when it is handed off to the wireless LAN, performs association (or negotiation) with the AP 400 to set up a packet delivery route. If the DHCP layer 401 of the AT 100 generates a DHCPDISCOVER message to search for the AR 500, the DHCPDISCOVER message is delivered to the AP 400 through the UDP layer, the IP layer, the 802.11 MAC layer, and the 802.11 PHY layer. At this point, the AT 100 is mapped to an 802.11 PHY layer of the AP 400, and the DHCPDISCOVER message is delivered to the AP 400.

The DHCPDISCOVER message delivered to the 802.11 PHY layer of the AP 400 is delivered to an L2 bridge (BRG) layer through an 802.11 MAC layer. The L2 BRG layer of the AP 400 performs 802.11-to-802.3 conversion to deliver the DHCPDISCOVER message to the AR 500, and delivers the DHCPDISCOVER message to an 802.3 PHY layer through an 802.3 MAC layer. Thereafter, if mapping is performed between the AP 400 and the AR 500 to deliver the DHCPDISCOVER message from the 802.3 PHY layer of the AP 400 to an 802.3 PHY layer of the AR 500, the DHCPDISCOVER message is delivered to the AR 500.

The DHCPDISCOVER message delivered to the 802.3 PHY layer of the AR 500 is delivered up to a DHCP layer 402 through an 802.3 PHY layer, an 802.3 MAC layer, an IP layer, and a UDP layer of the AR 500. In this manner, a preparation process for setting up a novel tunnel proposed between the AP 100 and the AR 500 is performed.

That is, DHCP (for example, DHCPDISCOVER, DHCPOFFER, DHCPINFORM, DHCPRELEASE, DHCPACK, etc.) messages having a DHCP message format as shown in Table 1 below, are exchanged between the DHCP layer 401 of the AT 100 and the DHCP layer 402 of the AR 500. Therefore, it can be noted that the AT 100, when it is handed off from the mobile communication network to the wireless LAN, delivers the existing IP address used in the mobile communication network and tunneling-related information to the AR 500 using the DHCP layers 401 and 402.

In addition, a novel tunnel proposed between the PDSN 300 and the AR 500 occurs between an AR [symbol] PDSN layer 403 of the AR 500, and an AR [symbol] PDSN layer 404 of the PDSN 300.

TABLE 1
1 2 3 4 5 6 7 8 9 0 1 2 3 4 5 6 7 8 9 0 1 2 3 4 5 6 7 8 9 0 1 2

| | | | |
|---|---|---|---|
| op(1) | htype(1) | hlen(1) | hops(l) |

xid(4)

| | |
|---|---|
| secs(2) | flags(2) |

ciaddr(4)
yiaddr(4)
siaddr(4)
giaddr(4)
chaddr(4)
sname(64)
file(128)
options(variable)

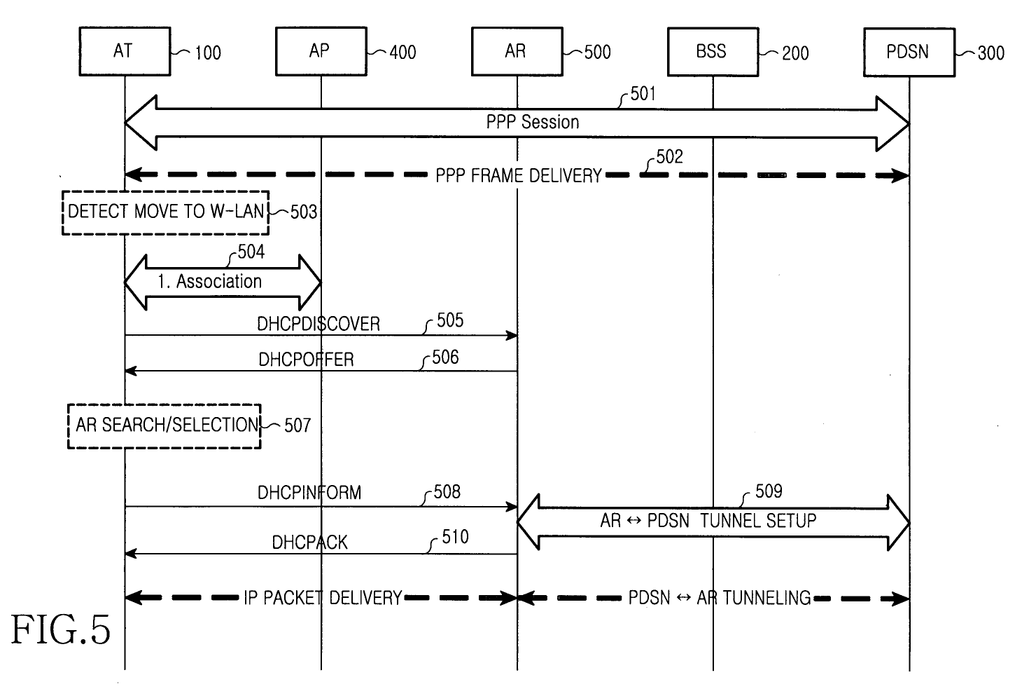

FIG. 5 is a signaling diagram for illustrating a handoff method between a mobile communication network and a wireless LAN according to an embodiment of the present invention.

In step 501, an AT 100 accesses a mobile communication network via a BSS 200 and sets up a PPP session to a PDSN 300, and the PDSN 300 allocates an IP address to the AT 100.

In step 502, the PDSN 300 delivers PPP frames to the AT 100 via the BSS 200. In step 503, the AT 100 detects its movement from the mobile communication network to a wireless LAN as the strength of signals transmitted and received to/from the BSS 200 becomes lower. Upon detecting the movement, the AT 100 performs association with an AP 400 to set up a packet delivery route in step 504. To search for an AR supporting handoff from the mobile communication network to the wireless LAN, the AT 100 generates a DHCPDISCOVER message with a ‘parameter request list option’ as shown in Table 2 below, and transmits the generated DHCPDISCOVER message to a plurality of APs on a broadcasting basis in step 505.

TABLE 2

| Field | Length (bytes) | Contents |
|---|---|---|
| code | 1 | 55 |
| len | 1 | 1 |
| parameter | 1 | 83 (DHCP option code |
| | | of A-P parameter option) |

The ‘parameter request list option’ of Table 2 is comprised of a 1-byte code field, a 1-byte length field, and a 1-byte parameter field. The parameter field comprises DHCP option code information of an ‘A-P parameter option’.

Among the plurality of APs, the AP 400 located nearest to the AT 100 receives the DHCPDISCOVER message generated by the AT 100 and delivers the DHCPDISCOVER message to all of the neighboring ARs 500 having a DHCP server function in step 505. Upon receiving the DHCPDISCOVER message with an ‘A-P parameter option’, the AR 500 generates a DHCPOFFER message with an ‘A-P parameter option’ as shown in Table 3 below, and transmits the generated DHCPOFFER message to the AT 100 on a unicast basis in step 506.

If the AR 500 supports buffering on IP packets delivered through a tunnel from the PDSN 300, the AR 500 sets a ‘BUF’ flag in a ‘capability’ field of the ‘A-P parameter option’ shown in Table 3 to ‘1’. If the AR 500 supports tunneling on the AT 100 that has moved from the mobile communication network to the wireless LAN, the AR 500 sets a ‘REV’ flag in the ‘capability’ field of the ‘A-P parameter option’ to ‘1’. In addition, the AR 500 informs the AT 100 of a serving node IP address used for tunneling to the PDSN 300 using a ‘serving AR IP’ field of the ‘A-P parameter option’. Herein, the “serving node” refers to a node that severs as an anchor node during handoff. For example, when the AT 100 moves from the mobile communication network to the wireless LAN, the PDSN 300 becomes the serving node, and when the AT 100 moves from the wireless LAN to the mobile communication network, the AR 500 becomes the serving node. A ‘tunnel protocol’ field represents types of various protocols used for tunneling.

TABLE 3

| Field | Length (bytes) | Contents | | | | | | | | |
|---|---|---|---|---|---|---|---|---|---|---|
| code | 1 | 83 | | | | | | | | |
| len | 1 | 6 | | | | | | | | |
| capability | 1 | 1 | 2 | 3 | 4 | 5 | 6 | 7 | 8 | BUF: support IP packet buffering |

| | | | |
|---|---|---|---|
| BUF | REV | reserved | REV: support reverse tunneling |

| | | |
|---|---|---|
| serving AR IP | 4 | IP address of AR that is used for PDSN −> AR tunneling |
| tunnel protocol | 1 | 47 (for GRE tunneling) |
| | | 94 (for IP within IP tunneling) |
| | | 17 (for UDP tunneling) |
| | | 6 (for TCP tunneling) |

Referring again to FIG. 5, in step 507, the AT 100 searches for and selects the AR 500 supporting handoff from the mobile communication network to the wireless LAN. In step 508, the AT 100 generates a DHCPINFORM message with a ‘first A-P tunnel request option’ as shown in Table 2, and transmits the DHCPINFORM message to the selected AR 500 on a unicast basis. Upon receiving the DHCPINFORM message with the ‘first A-P tunnel request option’, the AR 500 sets routing information for an IP address being used by the AT 100 in a ‘ciaddr’ field as shown in Table 1, and sets up a tunnel to the PDSN 300 using the ‘first A-P tunnel request option’. If the AT 100 requests setup of a tunnel from the AR 500 to the PDSN 300, the AT 100 transmits to the AR 500 the DHCPINFORM message, in which a ‘REV’ flag in a ‘request flag’ of a ‘first A-P tunnel request option’ as shown in Table 4 below is set to ‘1’. Then, in step 509, a tunnel is set up between the AR 500 and the PDSN 300.

In step 510, the AR 500, upon receiving the DHCPINFORM message with the ‘first A-P tunnel request option’ as shown in Table 4, generates a DHCPACK message and transmits the generated DHCPACK message to the AT 100 on a unicast basis.

TABLE 4

| Field | Length (bytes) | Contents | | | | | | | | |
|---|---|---|---|---|---|---|---|---|---|---|
| code | 1 | 84 | | | | | | | | |
| len | 1 | 5 | | | | | | | | |
| request flag | 1 | 1 | 2 | 3 | 4 | 5 | 6 | 7 | 8 | REL: A-P tunnel release request |

| | | | |
|---|---|---|---|
| REL | REV | reserved | REV: reverse tunneling request |

| | | |
|---|---|---|
| anchor IP | 4 | IP address of PDSN that is used for PDSN −> AR tunneling |

As shown in Table 4, the ‘first A-P tunnel request option’ comprises 1-byte code information, 1-byte length information, 1-byte request flag information, and 4-byte anchor IP information. Among them, the request flag information comprises a 1-bit A-P tunnel release request field, a 1-bit reverse tunneling request field, and a 6-bit reserved field.

The A-P tunnel release request field is used for requesting tunnel release between the AR 500 and the PDSN 300, and the reverse tunneling request field is used for requesting tunneling between the AR 500 and the PDSN 300.

In embodiments of the present invention, the request flag information used for setting up a tunnel between the AR 500 and the PDSN 300, and the anchor IP information used for adding routing information for an IP address being used by the AT 100 in the mobile communication network to the AR 500, are needed to maintain the existing IP address that the AT 100 was using in the mobile communication network before performing handoff from the mobile communication network to the wireless LAN.

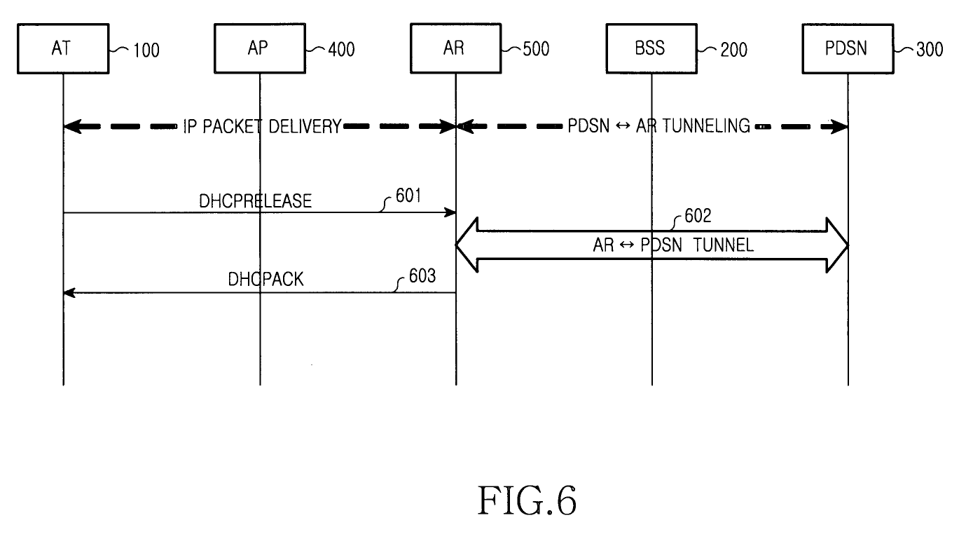

A method for releasing the tunnel between the AR 500 and the PDSN 300 will now be described herein below with reference to FIG. 6.

If the AT 100 no longer transmits/receives IP packets or if the AT 100 is powered off, the AT 100 can release the tunnel between the AR 500 and the PDSN 300 according to the following exemplary method.

In step 601, the AT 100 generates a DHCPRELEASE message with the ‘first A-P tunnel request option’ as shown in Table 4, and transmits the generated DHCPRELEASE message to the AR 500 on a unicast basis in order to release the tunnel between the AR 500 and the PDSN 300. In this case, a ‘REL’ flag in the ‘request flag’ field of the ‘first A-P tunnel request option’ is set to ‘1’.

In step 602, the AR 500 releases the tunnel to the PDSN 300 upon receiving the DHCPRELEASE message with the ‘first A-P tunnel request option’.

Thereafter, in step 603, the AR 500 generates a DHCPACK message and transmits the DHCPACK message to the AT 100 on a unicast basis to inform the AT 100 of the tunnel release.

In this manner, it is possible to perform handoff between the mobile communication network and the wireless LAN, and transmit/receive IP packets using the existing IP address.

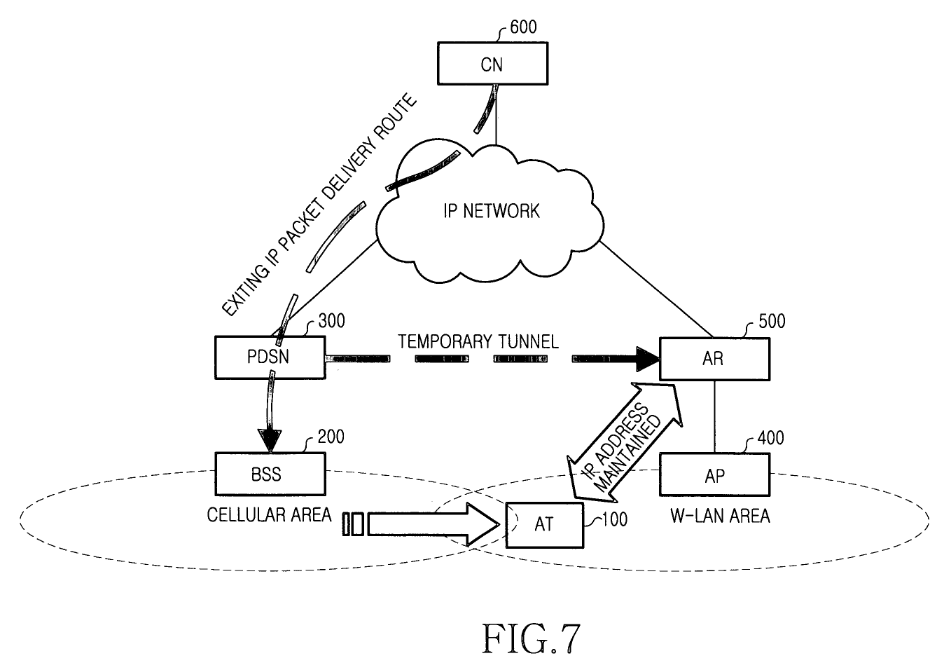

With reference to FIGS. 7 through 9, a description will now be made of an exemplary handoff system and method between a mobile communication network and a wireless LAN according to another embodiment of the present invention.

A description of a handoff system and method between a mobile communication network and a wireless LAN according to another embodiment of the present invention will be separately made for an operation before an AT performs handoff from the mobile communication network to the wireless LAN, and an operation after the AT performs handoff from the mobile communication network to the wireless LAN.

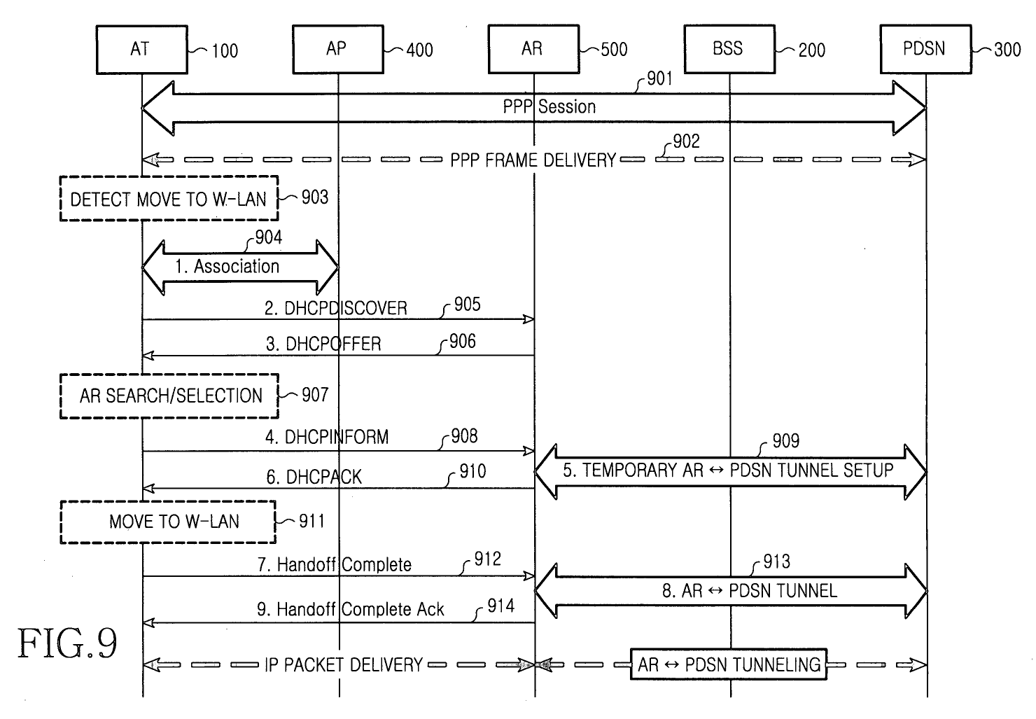

FIG. 7 illustrates an operation before an AT performs handoff from the mobile communication network to the wireless LAN. Before an AT 100, exchanging IP packets with a CN 600 that accesses the mobile communication network and performs data communication, performs handoff to the wireless LAN, the AT 100 detects its movement to the wireless LAN as it determines that while the strength of signals from a BSS 200 becomes lower, the strength of signals from an AP 400 in the wireless LAN becomes higher. To maintain the existing IP address used in the mobile communication network before the handoff to the wireless LAN, an AR 500 previously sets up a temporary tunnel to a PDSN 300 of the mobile communication network. The temporary tunnel is defined as an interface between the PDSN 300 and the AR 500. To set up the temporary tunnel, embodiments of the present invention propose a DHCP option format as shown in Table 5 below. Herein, the DHCP option format will be referred to as a ‘second A-P tunnel request option’. An exemplary method as to how a DHCP message with the ‘second A-P tunnel request option’ is used in embodiments of the present invention will be described in greater detail below with reference to FIG. 9.

TABLE 5

| Field | Length (bytes) | Contents | | | | | | | | |
|---|---|---|---|---|---|---|---|---|---|---|
| code | 1 | 84 | | | | | | | | |
| len | 1 | 5 | | | | | | | | |
| request flag | 1 | 1 | 2 | 3 | 4 | 5 | 6 | 7 | 8 | REL: A-P tunnel release request |

| | | | | |
|---|---|---|---|---|
| REL | REV | TMP | reserved | REV: reverse tunneling request |
| | | | | TMP: temporary A-P tunnel request |

| | | |
|---|---|---|
| anchor IP | 4 | IP address of PDSN that is used for PDSN −> AR tunneling |

As shown in Table 5, the ‘second A-P tunnel request option’ comprises 1-byte code information, 1-byte length information, 1-byte request flag information, and 4-byte anchor IP information. Among them, the request flag information comprises a 1-bit A-P tunnel release request field, a 1-bit reverse tunneling request field, a 1-bit temporary A-P tunnel request field, and a 5-bit reserved field.

The A-P tunnel release request field is used for requesting tunnel release between the AR 500 and the PDSN 300, the reverse tunneling request field is used for requesting tunneling between the AR 500 and the PDSN 300, and the temporary A-P tunnel request field is used for requesting a temporary tunnel between the AR 500 and the PDSN 300.

In embodiments of the present invention, the request flag information used for setting up a tunnel including a temporary tunnel between the AR 500 and the PDSN 300, and the anchor IP information used for adding routing information for an IP address being used by the AT 100 in the mobile communication network to the AR 500, are needed to maintain the existing IP address that the AT 100 was using in the mobile communication network before moving from the mobile communication network to the wireless LAN.

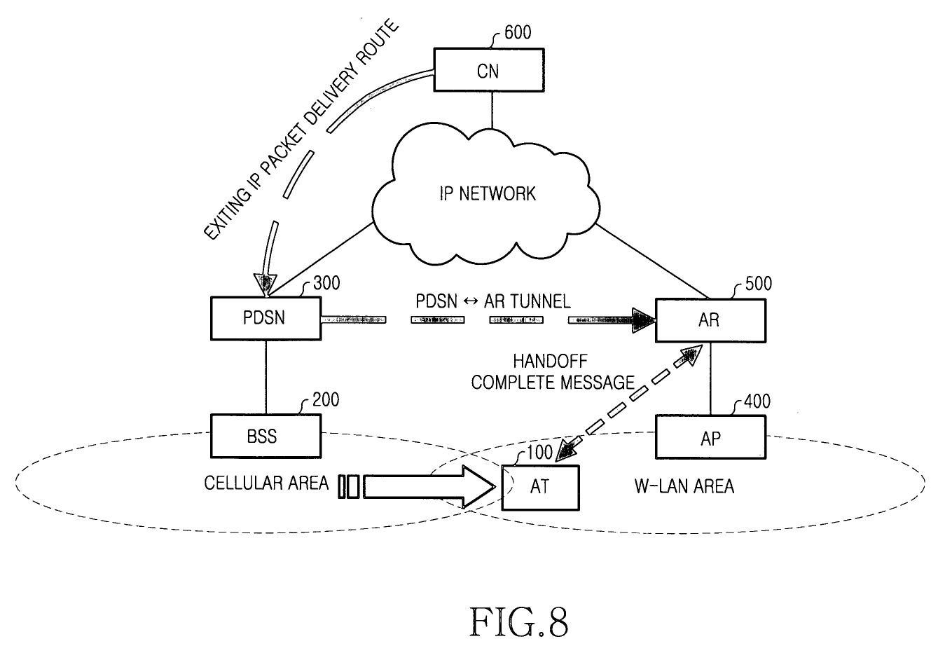

FIG. 8 illustrates an exemplary operation after an AT performs handoff from the mobile communication network to the wireless LAN. If the AT 100, exchanging IP packets with the CN 600 that accesses the mobile communication network and performs data communication, detects its movement to the wireless LAN, the AT 100 performs association for channel setup with the AP 400. Thereafter, the AT 100 searches for the AR 500 supporting handoff, and sends a Handoff Complete message to the AR 500 to perform handoff with the searched AR 500.

Therefore, if the AT 100, after moving to the wireless LAN, delivers IP packets to the CN 600 through the AR 500, the IP packets are not delivered to the CN 600 by a routing function of the AR 500, but are delivered to the PDSN 300 through the temporary tunnel thereto, and are then delivered to the CN 600 by a routing function of the PDSN 300.

In addition, if the AT 100, after moving to the wireless LAN, receives IP packets delivered from the CN 600 via the AR 500, the PDSN 300 seamlessly transmits the IP packets received from the CN 600 to the AR 500 via the previously set temporary tunnel, and the AR 500 transmits the IP packets received from the PDSN 300 to the AT 100 via the AP 400.

FIG. 9 is a signaling diagram for illustrating an exemplary handoff method between a mobile communication network and a wireless LAN according to another embodiment of the present invention.

In step 901, an AT 100 accesses a mobile communication network via a BSS 200 and sets up a PPP session to a PDSN 300, and the PDSN 300 allocates an IP address to the AT 100.

In step 902, the PDSN 300 delivers PPP frames to the AT 100 via the BSS 200. In step 903, the AT 100 detects its movement from the mobile communication network to a wireless LAN as the strength of signals transmitted and received to/from the BSS 200 becomes lower. Upon detecting the movement, the AT 100 performs association with an AP 400 to set up a packet delivery route in step 904. After the association with the AP 400, the AT 100 generates a DHCPDISCOVER message and transmits the generated DHCPDISCOVER message to a plurality of APs on a broadcasting basis to search for an AR 500 supporting handoff from the mobile communication network to the wireless LAN in step 905.

The DHCPDISCOVER message comprises a ‘parameter request list option’ as shown in Table 6 below.

TABLE 6

| Field | Length (bytes) | Contents |
|---|---|---|
| code | 1 | 55 |
| len | 1 | 1 |
| parameter | 1 | 83 (DHCP option code |
| | | of A-P parameter option) |

As shown in Table 6, the ‘parameter request list option’ comprises a 1-byte code field, a 1-byte length field, and a 1-byte parameter field. The parameter field comprises DHCP option code information of an A-P parameter option.

Among the plurality of APs, the AP 400 located nearest to the AT 100 receives the DHCPDISCOVER message generated by the AT 100 and delivers the DHCPDISCOVER message to all of the neighboring ARs 500 having a DHCP server function in step 905. As a result, the AT 100 delivers the ‘parameter request list option’ included in the DHCPDISCOVER message to the AR 500.

Upon receiving the DHCPDISCOVER message, the AR 500 supporting handoff from the mobile communication network to the wireless LAN generates a DHCPOFFER message for responding to the DHCPDISCOVER message and delivers the DHCPOFFER message to the AT 100 on a unicast basis in step 906. The DHCPOFFER message generated by the AR 500 comprises an option indicating that the AR 500 supports vertical handoff from the mobile communication network to the wireless LAN.

In step 907, upon receiving the DHCPOFFER message with an option indicating support of vertical handoff from the mobile communication network to the wireless LAN, the AT 100 searches for and selects the AR 500. In step 908, the AT 100 generates a DHCPINFORM message and delivers the DHCPINFORM message to the selected AR 500. The DHCPINFORM message generated by the AT 100 comprises the ‘second A-P tunnel request option’ as shown in Table 5. In this manner, the AT 100 provides the AR 500 with the information needed for setting up the temporary tunnel.

In the process of step 908, the AT 100 requests the information needed for setting up the temporary tunnel between the AR 500 and the PDSN 300 by setting a ‘TMP (temporary)’ flag of the ‘second A-P tunnel request option’ in the DHCPINFORM message. Upon receiving the DHCPINFORM message with the ‘second A-P tunnel request option’, the AR 500 adds routing information for an IP address currently being used by the AT 100 using anchor IP information and sets up a temporary tunnel to the PDSN 300 using the ‘second A-P tunnel request option’ included in the DHCPINFORM message in step 909.

If the temporary tunnel to the PDSN 300 is successfully set up, the AR 500 generates a DHCPACK message and delivers the DHCPACK message to the AT 100 in step 910 to inform the AT 100 of the successful setup of the temporary tunnel to the PDSN 300.

If the AT 100 fully moves from the mobile communication network to the wireless LAN in step 911 after the temporary tunnel between the AR 500 and the PDSN 300 is set up, the AT 100 generates a Handoff Complete message in which a ‘TMP’ flag of the ‘second A-P tunnel request option’ in the DHCPINFORM message is set to ‘0’, and delivers the Handoff Complete message to the AR 500 in step 912.

Upon receiving the Handoff Complete message from the AT 100, the AR 500 changes the temporary tunnel to the PDSN 300 to a normal tunnel in step 913.

In step 914, the AR 500 generates a Handoff Complete ACK message as a response message for the Handoff Complete message and delivers the Handoff Complete ACK message to the AT 100.

Thereafter, the AT 100 can receive IP packets transmitted from the CN 300 via the tunnel between the AR 500 and the PDSN 300.

As can be understood from the foregoing description, embodiments of the present invention can solve the problems of the conventional handoff method not using Mobile IP, in which every time the AT moves from the mobile communication network to the wireless LAN, a new IP address is allocated such that upper layer sessions cannot be maintained and the packets delivered to the existing IP address cannot be delivered to the AT. In addition, embodiments of the present invention can also be applied to handoff from the wireless LAN to the mobile communication network. In this case, the AT also maintains its own existing IP address during handoff, thereby maintaining upper layer sessions and reducing packet loss.

Unlike the conventional method in which Mobile IP-based mobility of the AT must be supported in the mobile communication network and the wireless LAN to provide a seamless handoff service, embodiments of the present invention can support internetwork mobility regardless of whether Mobile IP is supported or not. In addition, IP tunneling is dispersed over the PDSN through the AR in order to solve the problem of concentrating IP tunneling on the HA for delivering IP packets to a network where the AT is located.

While the invention has been shown and described with reference to a certain exemplary embodiments thereof, it will be understood by those skilled in the art that various changes in form and details may be made therein without departing from the spirit and scope of the invention as defined by the appended claims.

What is claimed is:

1. A method for performing handoff from a mobile communication network, including a packet data service node (PDSN) connected to a base station system (BSS) for supporting an Internet protocol (IP) routing function, to a wireless local area network (LAN) including an access router (AR) supporting the IP routing function, the method comprising the steps of:
detecting by an access terminal (AT), the AT movement to the wireless LAN;
exchanging between the AT and the AR, information for tunneling between the PDSN and the AR;
setting up a tunnel for packet delivery between the AR and the PDSN; and
delivering packets to the AT via the set tunnel.

2. The method of claim 1, wherein the tunneling information delivered from the AR to the AT comprises:
information indicating whether the AR supports buffering on the packets delivered from the PDSN, information indicating whether the AR supports tunneling to the PDSN, and information on a serving node IP address used for tunneling between the AR and the PDSN.

3. The method of claim 1, wherein the tunneling information delivered from the AT to the AR comprises an existing IP address used by the AT in the mobile communication network.

4. The method of claim 1, further comprising the step of:
delivering the tunneling information through an exchange of a dynamic host configuration protocol (DHCP) message between the AT and the AR.

5. The method of claim 3, further comprising the step of:
delivering the tunneling information from the AT to the AR through an exchange of a DHCP message between the AT and the AR, wherein the DHCP message comprises a field for requesting setup of a tunnel from the AR to the PDSN.

6. The method of claim 1, further comprising the steps of:
setting up a tunnel for packet delivery from the AR to the PDSN; and
delivering packets delivered from the AT to the CN connected to an external IP network via the set tunnel.

7. The method of claim 1, further comprising the step of:
releasing the tunnel through an exchange of a DHCP message with the AR if the AT no longer receives packets after the tunnel is set up.

8. A wireless communication system for performing handoff of an access terminal (AT) that moves from a mobile communication network, including a packet data service node (PDSN) connected to a base station system (BSS) for supporting an Internet protocol (IP) routing function, to a wireless local area network (LAN) including an access router (AR) supporting the IP routing function, the system comprising:
the AT having a dual-mode function capable of accessing both the mobile communication network and the wireless LAN, for exchanging information with the AR for tunneling between the PDSN and the AR when the AT moves from the mobile communication network to the wireless LAN; and
the AR for receiving the tunneling information from the AT, setting up a tunnel for packet delivery with the PDSN according to the received tunneling information, and delivering packets to the AT via the set tunnel.

9. The wireless communication system of claim 8, wherein the tunneling information delivered from the AR to the AT comprises:
information indicating whether the AR supports buffering on the packets delivered from the PDSN, information indicating whether the AR supports tunneling to the PDSN, and information on a serving node IP address used for tunneling between the AR and the PDSN.

10. The wireless communication system of claim 8, wherein the tunneling information delivered from the AT to the AR comprises an existing IP address used by the AT in the mobile communication network.

11. The wireless communication system of claim 8, wherein the tunneling information is delivered through an exchange of a dynamic host configuration protocol (DHCP) message between the AT and the AR.

12. The wireless communication system of claim 10, wherein the tunneling information delivered from the AT to the AR is delivered through an exchange of a DHCP message between the AT and the AR, wherein the DHCP message comprises a field for requesting setup of a tunnel from the AR to the PDSN.

13. The wireless communication system of claim 8, wherein the AR is configured to deliver packets delivered from the AT to the CN connected to an external IP network via the set tunnel.

14. The wireless communication system of claim 8, wherein the AT is configured to release the tunnel through an exchange of a DHCP message with the AR if the AT no longer receives packets after the tunnel is set up.

15. A method for performing handoff from a mobile communication network, including a packet data service node (PDSN) connected to a base station system (BSS) for supporting an Internet protocol (IP) routing function, to a wireless local area network (LAN) including an access router (AR) supporting the IP routing function, the method comprising the steps of:
detecting by an access terminal (AT), the AT movement to the wireless LAN;
exchanging by the AT, information with the AR for temporary tunneling between the PDSN and the AR before the handoff to the wireless LAN;
setting up a temporary tunnel for packet delivery between the AR and the PDSN;
transmitting by the AT, a handoff complete message for tunneling request to the AR after the handoff to the wireless LAN;
setting up a tunnel between the AR and the PDSN; and
delivering packets to the AT via the set tunnel.

16. The method of claim 15, wherein the temporary tunneling information delivered from the AR to the AT comprises information indicating whether the AR supports handoff from the mobile communication network to the wireless LAN.

17. The method of claim 15, wherein the temporary tunneling information delivered from the AT to the AR comprises an existing IP address used by the AT in the mobile communication network.

18. The method of claim 15, further comprising the step of:
delivering the temporary tunneling information through an exchange of a dynamic host configuration protocol (DHCP) message between the AT and the AR.

19. The method of claim 17, further comprising the step of:
delivering the temporary tunneling information from the AT to the AR through an exchange of a DHCP message between the AT and the AR, wherein the DHCP message comprises a field for requesting setup of a temporary tunnel from the AR to the PDSN.

20. The method of claim 15, further comprising the steps of:
setting up a tunnel for packet delivery from the AR to the PDSN; and
delivering packets delivered from the AT to the CN connected to an external IP network via the set tunnel.

21. A method for performing handoff by an access terminal (AT) that moves from a mobile communication network, including a packet data service node (PDSN) connected to a base station system (BSS) for supporting an Internet protocol (IP) routing function, to a wireless local area network (LAN) including an access router (AR) supporting the IP routing function, the method comprising the steps of:
detecting the AT movement from the mobile communication network to the wireless LAN;
exchanging information with the AR for tunneling between the PDSN and the AR; and
if a tunnel for packet delivery between the AR and the PDSN is set up, receiving packets via the set tunnel.

22. The method of claim 21, wherein the tunneling information delivered from the AR to the AT comprises:
information indicating whether the AR supports buffering on the packets delivered from the PDSN, information indicating whether the AR supports tunneling to the PDSN, and information on a serving node IP address used for tunneling between the AR and the PDSN.

23. The method of claim 21, wherein the tunneling information delivered from the AT to the AR comprises an existing IP address used by the AT in the mobile communication network.

24. The method of claim 21, further comprising the step of:
delivering the tunneling information through an exchange of a dynamic host configuration protocol (DHCP) message between the AT and the AR.

25. The method of claim 23, further comprising the step of:
delivering the tunneling information from the AT to the AR through an exchange of a DHCP message between the AT and the AR, wherein the DHCP message comprises a field for requesting setup of a tunnel from the AR to the PDSN.

26. The method of claim 21, further comprising the steps of:
setting up a tunnel for packet delivery from the AR to the PDSN; and
delivering packets to the CN connected to an external IP network via the set tunnel.

27. The method of claim 21, further comprising the step of:
releasing the tunnel through an exchange of a DHCP message with the AR if the AT no longer receives packets after the tunnel is set up.

28. A method for performing handoff by an access terminal (AT) that moves from a mobile communication network, including a packet data service node (PDSN) connected to a base station system (BSS) for supporting an Internet protocol (IP) routing function, to a wireless local area network (LAN) including an access router (AR) supporting the IP routing function, the method comprising the steps of:
detecting the AT movement from the mobile communication network to the wireless LAN;
exchanging information with the AR for temporary tunneling between the PDSN and the AR before the handoff to the wireless LAN;
if a temporary tunnel for packet delivery between the AR and the PDSN is set up, transmitting a handoff complete message for tunneling request to the AR after the handoff to the wireless LAN; and
if a tunnel between the AR and the PDSN is set up, receiving packets via the set tunnel.

29. The method of claim 28, wherein the temporary tunneling information delivered from the AR to the AT comprises information indicating whether the AR supports handoff from the mobile communication network to the wireless LAN.

30. The method of claim 28, wherein the temporary tunneling information delivered from the AT to the AR comprises an existing IP address used by the AT in the mobile communication network.

31. The method of claim 28, further comprising the step of:
delivering the temporary tunneling information through an exchange of a dynamic host configuration protocol (DHCP) message between the AT and the AR.

32. The method of claim 30, further comprising the step of:
delivering the temporary tunneling information from the AT to the AR through an exchange of a DHCP message between the AT and the AR, wherein the DHCP message comprises a field for requesting setup of a temporary tunnel from the AR to the PDSN.

33. The method of claim 28, further comprising the steps of:
if a tunnel for packet delivery from the AR to the PDSN is set up, delivering packets to the CN connected to an external IP network via the set tunnel.

34. A handoff method between a mobile communication network and wireless local area network (LAN) performed by an access router (AR) in a wireless communication system for performing handoff of an access terminal (AT) that moves from the mobile communication network, including a packet data service node (PDSN) connected to a base station system (BSS) for supporting an Internet protocol (IP) routing function, to the wireless LAN including the AR supporting the IP routing function, the method comprising the steps of:
detecting movement of the AT from the mobile communication network to the wireless LAN, and exchanging information with the AT for tunneling between the PDSN and the AR;
setting up a tunnel for packet delivery with the PDSN; and
delivering packets to the AT via the set tunnel.

35. The handoff method of claim 34, wherein the tunneling information delivered from the AR to the AT comprises:
information indicating whether the AR supports buffering on the packets delivered from the PDSN, information indicating whether the AR supports tunneling to the PDSN, and information on a serving node IP address used for tunneling between the AR and the PDSN.

36. The handoff method of claim 34, wherein the tunneling information delivered from the AT to the AR comprises an existing IP address used by the AT in the mobile communication network.

37. The handoff method of claim 34, further comprising the step of:
delivering the tunneling information through an exchange of a dynamic host configuration protocol (DHCP) message with the AT.

38. The handoff method of claim 36, further comprising the step of:
delivering the tunneling information from the AT through an exchange of a DHCP message with the AT, wherein the DHCP message comprises a field for requesting setup of a tunnel from the AR to the PDSN.

39. The handoff method of claim 34, further comprising the steps of:
setting up a tunnel for packet delivery from the AR to the PDSN; and
delivering packets delivered from the AT to the CN connected to an external IP network via the set tunnel.

40. The handoff method of claim 34, further comprising the step of:
releasing the tunnel through an exchange of a DHCP message with the AT if the AT no longer receives packets after the tunnel is set up.

41. A handoff method between a mobile communication network and wireless local area network (LAN) performed by an access router (AR) in a wireless communication system for performing handoff of an access terminal (AT) that moves from the mobile communication network, including a packet data service node (PDSN) connected to a base station system (BSS) for supporting an Internet protocol (IP) routing function, to the wireless LAN including the AR supporting the IP routing function, the method comprising the steps of:
detecting movement of the AT from the mobile communication network to the wireless LAN, and exchanging information with the AT for temporary tunneling between the PDSN and the AR before the handoff to the wireless LAN;
setting up a temporary tunnel for packet delivery with the PDSN;
receiving a handoff complete message for tunneling request from the AT after the handoff of the AT to the wireless LAN; and
if a tunnel to the PDSN is set up, delivering packets to the AT via the set tunnel.

42. The handoff method of claim 41, wherein the temporary tunneling information delivered from the AR to the AT comprises information indicating whether the AR supports handoff from the mobile communication network to the wireless LAN.

43. The handoff method of claim 41, wherein the temporary tunneling information delivered from the AT to the AR comprises an existing IP address used by the AT in the mobile communication network.

44. The handoff method of claim 41, further comprising the step of:
delivering the temporary tunneling information through an exchange of a dynamic host configuration protocol (DHCP) message with the AT.

45. The handoff method of claim 43, further comprising the step of:
delivering the temporary tunneling information from the AT to the AR through an exchange of a DHCP message between the AT and the AR, wherein the DHCP message comprises a field for requesting setup of a temporary tunnel from the AR to the PDSN.

46. The handoff method of claim 41, further comprising the steps of:
setting up a tunnel for packet delivery from the AR to the PDSN; and
delivering packets delivered from the AT to the CN connected to an external IP network via the set tunnel.
